(19) United States
(12) Patent Application Publication
(10) Pub. No.: US 2026/0299819 A1
(43) Pub. Date: Oct. 1, 2026

(54) DISTILLATION-TELEPORTATION PROTOCOL FOR FAULT-TOLERANT QUANTUM RANDOM ACCESS MEMORY (QRAM)

(71) Applicant: Amazon Technologies, Inc., Seattle, WA (US)

(72) Inventors: Alexander Moos DALZELL, San Francisco, CA (US); Samuel MCARDLE, Los Angeles, CA (US); Connor HANN, Los Angeles, CA (US); Fernando BRANDAO, Pasadena, CA (US)

(21) Appl. No.: 19/252,347

(22) Filed: Jun. 27, 2025

Related U.S. Application Data
(60) Provisional application No. 63/781,562, filed on Apr. 1, 2025.

(51) Int. Cl. G06F 3/06; G06N 10/60

(52) U.S. Cl. CPC G06F 3/0655; G06F 3/0604; G06F 3/0673; G06N 10/60

(57) ABSTRACT

A distillation-teleportation protocol for fault-tolerant quantum random access memory (QRAM) is provided. The protocol may include preparing multiple copies of a faulty physical QRAM resource state. The physical resource states may then be encoded into respective encoded logical resource states, which can then be distilled into a single high-fidelity logical resource state. The high-fidelity logical resource state may then be quantum teleported to enact a logical QRAM gate, up to a correction which can be computed classically.

### CROSS REFERENCE TO RELATED APPLICATIONS

This application claims the benefit of priority to U.S. Provisional Patent Application No. 63/781,562, entitled, “Distillation-Teleportation Protocol for Fault-Tolerant Quantum Random Access Memory (QRAM)”, filed on Apr. 1, 2025, the disclosure of which is hereby incorporated herein in its entirety.

### BACKGROUND

In classical computers, information is stored as bits in arrays of memory cells, each having a corresponding address. When reading or writing a bit of information to a memory cell in a classical computer, the memory cell is accessed using the address of that memory cell to activate a column line and a row line that intersect at the location that memory cell. In these classical computers, memory cells are accessed one at a time.

### BRIEF DESCRIPTION OF THE DRAWINGS

Certain features of the subject technology are set forth in the appended claims. However, for the purpose of explanation, several embodiments of the subject technology are set forth in the following figures.

FIG. 1 is a block diagram depicting a system including a quantum computer according to aspects of the subject technology.

FIG. 2 is a block diagram illustrating a quantum computing system having a quantum random access memory (QRAM) device according to aspects of the subject technology.

FIG. 3 is an example of a passive QRAM device according to aspects of the subject technology.

FIG. 4 is a quantum circuit diagram depicting an example of a distillation-teleportation protocol according to aspects of the subject technology.

FIG. 5 is a quantum circuit diagram depicting an example of a quantum teleportation operation according to aspects of the subject technology.

FIG. 6A is a quantum circuit diagram depicting an example of a distillation operation according to aspects of the subject technology.

FIG. 6B is a schematic diagram of a distillation operation including multiple instances of the distillation operation of FIG. 6A according to aspects of the subject technology.

FIG. 7 is a quantum circuit diagram depicting another example of a distillation-teleportation protocol according to aspects of the subject technology.

FIG. 8 is a quantum circuit diagram depicting an example of a partial Clifford twirling operation that may optionally be included in the distillation-teleportation protocols of FIG. 4 or 7 according to aspects of the subject technology.

FIG. 9 is a flowchart of illustrative operations that may be performed for a distillation-teleportation protocol for fault-tolerant quantum random access memory (QRAM) according to aspects of the subject technology.

FIG. 10 is another flowchart of illustrative operations that may be performed for a distillation-teleportation protocol for fault-tolerant quantum random access memory (QRAM) according to aspects of the subject technology.

FIG. 11 illustrates an example electronic device in which aspects of the subject technology may be used, in accordance with one or more embodiments of the subject technology.

### DETAILED DESCRIPTION

The description set forth below describes various configurations of the subject technology and is not intended to represent the only configurations in which the subject technology may be practiced. The appended drawings are incorporated herein and constitute a part of the description. The description includes specific details for the purpose of providing an understanding of the subject technology. However, the subject technology is not limited to the specific details set forth herein and may be practiced using one or more other embodiments of the subject technology. In one or more embodiments of the subject technology, structures and components are shown in block diagram form in order to avoid obscuring the concepts of the subject technology.

The present description relates generally to quantum computing, and more particularly to, for example, state injection using erasure qubits.

The development of fast and large-scale random access memory (RAM) has played an indispensable role in the development of classical computing. As used herein, references to classical computing resources refers to non-quantum based computing resources and associated technologies (e.g., binary-based computing resources). Early RAM devices assisted in the first demonstrations of stored-program electronic computers, and today, the availability of efficient high-speed RAM enables data-intensive computing applications in areas like machine learning. RAM performs the following operation: retrieve one of 2ⁿ data items ƒ(x), given, as input, the n-bit address x specifying its location in memory. In practice, the access time for RAM can be astonishingly fast: modern RAM chips can achieve latency of 10 nanoseconds or faster. Furthermore, the RAM runtime is independent of the location of the data within the memory, and latency can remain low even as the overall size of the memory is scaled up. However, in classical RAM, only a single data bit can be addressed at a time.

As discussed herein, quantum random access memory (QRAM) may use an n-qubit address register in a quantum superposition Σₓαₓ|x [symbol] of all 2ⁿ addresses in a classical RAM, to load all 2ⁿ data bits stored in the classical RAM as a quantum superposition (e.g., to simultaneously access, in superposition, all 2ⁿ data bits stored in the classical RAM).

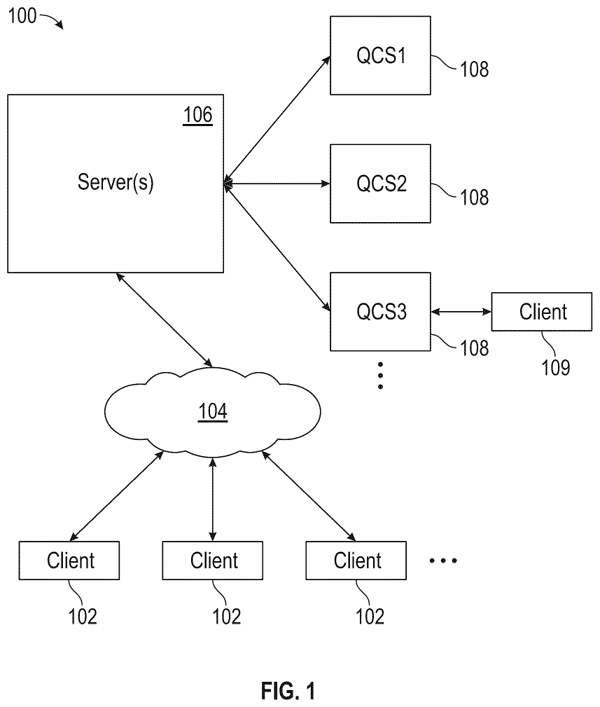

FIG. 1 is a block diagram depicting a system that may incorporate a quantum computer according to aspects of the subject technology. Not all of the depicted components may be required, however, and one or more implementations may include additional components not shown in the figure. Variations in the arrangement and type of the components may be made without departing from the spirit or scope of the claims as set forth herein. Depicted or described connections and couplings between components are not limited to direct connections or direct couplings and may be implemented with one or more intervening components unless expressly stated otherwise.

As depicted in FIG. 1, a system 100 may include one or more client devices 102, one or more servers 106, and/or one or more quantum computing systems 108. As shown, the client devices 102 may be communicatively coupled to the server(s) 106 via a network 104. For example, the network 104 may represent one or more local area networks (LANs) and/or one or more wider area networks, such as the Internet. In one or more implementations, the server(s) 106 may implement one or more web services that can be accessed by one or more of the client devices 102 via the network 104. In one or more implementations, the web services provided by the servers 106 may include quantum computing services. For example, the server(s) 106 may facilitate access to one or more of the quantum computing systems 108, such as from a client device 102.

In the example of FIG. 1, the quantum computing systems 108 include a first quantum computing system, QCS1, a second quantum computing system, QCS2, and a third quantum computing system, QCS3. However, it is appreciated that this is merely illustrative, and the system 100 may include more or fewer than three quantum computing systems in other implementations. In various examples, the multiple quantum computing systems QCS1, QCS2, and QCS3 may represent multiple instances of a same or similar type of quantum computing system, or implementations of multiple different types of quantum computing systems. For example, different types of quantum computing systems may implement different types of qubit architectures, as will be discussed in further detail hereinafter.

Although FIG. 1 illustrates an example in which one or more quantum computing systems can be accessed by a web services provider, in one or more implementations, one or more of the quantum computing systems 108 may also, or alternatively, be accessible directly (e.g., locally at the quantum computing system). For example, FIG. 1 also illustrates how a quantum computing system 108 may be accessed directly from a client interface 109 that is directly communicatively coupled to the quantum computing system 108. For example, the client interface 109 may include one or more input/output components, such as keyboards, display screens, touch interfaces, etc. that can be operated by a user to control an associated quantum computing system 108. In one or more implementations, the client interface 109 and the quantum computing system 108 can be integrated into a common package (e.g., as a standalone quantum computer).

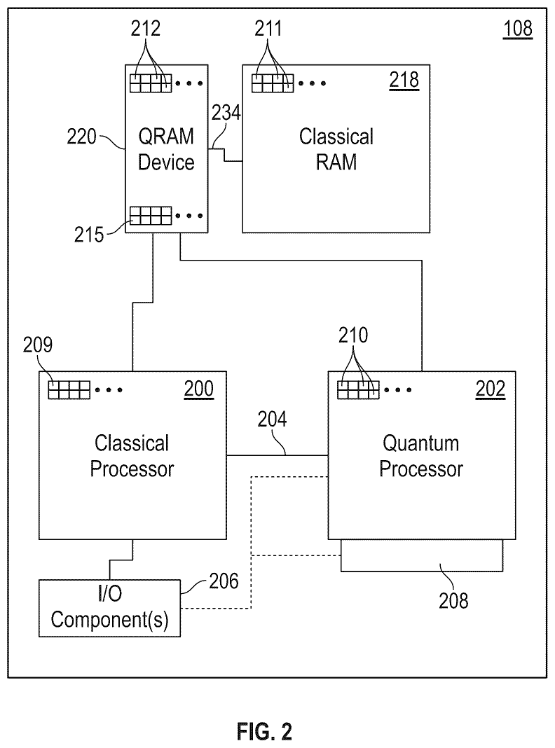

FIG. 2 is a block diagram depicting an example of a quantum computing system according to aspects of the subject technology. In the example of FIG. 2, the quantum computing system 108 may include classical computing components (e.g., one or more classical processors, such as a classical processor 200, and/or one or more classical memory devices, such as classical RAM 218) and quantum computing components (e.g., one or more quantum processors, such as a quantum processor 202, and/or one or more quantum RAM (QRAM) devices, such as QRAM device 220). In this example, the classical processor 200 is coupled to the quantum processor 202 via an interface 204 over which control signals can be sent from the classical processor 200 to the quantum processor 202. In this example, the quantum computing system 108 may include one or more input/output components 206, such as keyboards, display screens, touch interfaces, etc. that can be operated by a user to control the classical processor 200, such as for generating commands and/or associated control signals for the quantum processor 202.

In the example of FIG. 2, the quantum computing system 108 may include drive circuitry 208 for the quantum processor 202. For example, the drive circuitry 208 may include one or more electromagnetic pulse generators (e.g., microwave pulse generators, such as one more lasers and/or other light sources), and/or corresponding electrical and/or optical pathways for guiding electromagnetic pulses to one or more qubits 210 of the quantum processor, for controlling operation of the quantum processor 202. In the example of FIG. 2, the drive circuitry 208 is depicted as being arranged along an edge of the quantum processor 202. However, this is merely illustrative, and, in various implementations, the drive circuitry 208 may be otherwise arranged with respect to, and or integrated within, a classical computer incorporating the classical processor 200 or the quantum processor 202.

As illustrated in FIG. 2, the classical processor 200 may include transistors 209 (e.g., thousands, millions, billions, or trillions of transistors 209). For example, the transistors 209 may be formed in a silicon substrate using one or more semiconductor processing operations (e.g., etching, lithography, etc.). The classical processor 200 may include classical logic gates (e.g., thousands, millions, billions, or trillions of classical logic gates), each formed by combinations of one or more of the transistors 209 and/or other circuit elements formed in the silicon substrate.

Although the example of FIG. 2 depicts a quantum computing system 108 that includes a classical processor 200, it is appreciated that, in one or more implementations, a quantum computing system 108 may be provided without a classical processor 200. For example, as indicated by the dashed lines in FIG. 2, in one or more implementations, input/output (I/O) components 206 may be directly coupled to the quantum processor 202 and/or the drive circuitry 208 for controlling operation of the quantum processor 202 without involvement of a classical processor 200.

As shown, the quantum processor 202 may include qubits 210 (e.g., tens, hundreds, thousands, millions, or more than millions of qubits 210). Each qubit 210 may represent a single physical qubit, or may represent a logical qubit, which may be formed from one, two, or more than two physical qubits. In various implementations, qubits 210 may be implemented as trapped-ion qubits (e.g., including trapped ionized ytterbium atoms), superconducting qubits (e.g., transmons), Rydberg atom qubits, tunable superconducting qubits, quantum dot qubits, topological qubits, photonic qubits, Nuclear Magnetic Resonance (NMR) qubits, diamond nitrogen-vacancy (NV) center qubits, neutral atom qubits, and/or any other suitable qubit architectures and/or quantum-scale anharmonic systems. In some implementations, qubits 210 may be implemented on, within, and/or located with respect to a substrate (e.g., a silicon, gallium arsenide, graphene, sapphire, aluminum nitride, and silicon carbide, or other substrate). For example, some qubits may be implemented using a superconducting loop on a silicon substrate. In other implementations, qubits may be implemented separately from a substrate of the quantum processor 202.

Qubits 210 may be used, by the quantum processor 202, individually and/or in various combinations, for storage of information, and/or for implementation of one or more quantum logic gates and/or surface codes, as discussed in further detail hereinafter, such as for execution of one or more quantum computations and/or algorithms.

As shown in FIG. 2, the classical RAM 218 may include memory cells 211 (e.g., an array or register of memory cells). For example, the memory cells 211 may include capacitors (e.g., in a dynamic RAM or DRAM implementation) and/or flip-flops (e.g., in a static RAM or SRAM implementation). The capacitors and/or flip-flops may be implemented on a semiconductor substrate.

As shown, the QRAM device may include one or more qubits 212 and/or one or more qubits 215. For example, qubits 212 may be used as part of a quantum address register and/or bus register for the QRAM device, and the qubits 215 may be used as data qubits for the QRAM device. In the example of FIG. 2, the qubits 212 and the qubits 215 are part of the same QRAM device 220. In one or more other implementations, the qubits 215 may be external to the QRAM device 220 (e.g., the qubits 215 may be part of the quantum processor 202 or another quantum storage device).

In the example of FIG. 2, a single QRAM device 220 is shown. However, it is appreciated that multiple QRAM devices 220 may be coupled to the classical RAM 218 via one or more respective interfaces 234 (e.g., wires, wire bonds, conductive traces in flexible or rigid substrates, and/or the like). In one or more implementations, the QRAM device 220 may be, or may include, one or more faulty physical QRAM oracles that utilize the qubits 212. In one or more implementations, the QRAM device 220 may include control circuitry (e.g., classical control circuitry, such as classical processing circuitry and/or a controller similar to the drive circuitry 208 for the quantum processor 202) that performs one or more of the operations disclosed herein. In one or more other implementations, the classical processor 200, the drive circuitry 208, and/or the quantum processor 202 may interact with the qubits 212 of the QRAM device to perform one or more of the operations disclosed herein.

Each qubit 212 and/or each qubit 215 may represent a single physical qubit, or may represent a logical qubit, which may be formed from one, two, or more than two physical qubits. In various implementations, qubits 212 and/or 215 may be implemented as trapped-ion qubits (e.g., including trapped ionized ytterbium atoms), superconducting qubits (e.g., transmons), Rydberg atom qubits, tunable superconducting qubits, quantum dot qubits, topological qubits, photonic qubits, Nuclear Magnetic Resonance (NMR) qubits, diamond nitrogen-vacancy (NV) center qubits, neutral atom qubits, and/or any other suitable qubit architectures and/or quantum-scale anharmonic systems. In some implementations, qubits 212 and/or 215 may be implemented on, within, and/or located with respect to a substrate (e.g., a silicon, gallium arsenide, graphene, sapphire, aluminum nitride, and silicon carbide, or other substrate). For example, some qubits may be implemented using a superconducting loop on a silicon substrate. In other implementations, qubits 212 and/or 215 may be implemented separately from a substrate of the quantum processor 202 (e.g., using photon phases to store quantum information). As discussed in various examples herein, multiple qubits 212 (e.g., a set of multiple qubits 212) may be used to store a quantum state. In some examples discussed herein, multiple sets of the qubits 212 may be used to store, respectively, multiple erroneous versions of the quantum state.

In one or more implementations, the QRAM device 220 may be configured to perform a quantum read out, into a quantum superposition, of multiple (e.g., all) of the data bits stored in the memory cells 211 of the classical RAM 218, and may provide information corresponding to the quantum read out of the data bits to the classical processor 200 and/or provide the quantum superposition to the quantum processor 202. For example, the quantum processor 202 may execute one or more quantum computations and/or quantum algorithms using a quantum state that represents the quantum read out from the classical RAM 218 by the QRAM device 220. In one or more implementations, the QRAM device 220 may be configured to write information into the memory cells 211 of the classical RAM 218, such as to write information received from the classical processor 200 and/or the quantum processor 202 to the classical RAM 218 (e.g., data bits generated as the result of one or more quantum computations and/or quantum algorithms executed by the quantum processor 202).

As examples, quantum computations that may utilize the QRAM device 220 to access (e.g., read from and/or write to) the classical RAM 218 may include quantum machine learning algorithms (e.g., for support vector machines, Gaussian process regression, and recommendation systems), quantum algorithms for solving differential equations (e.g., by discretizing the equations and inverting the resulting linear systems, such as using queries to the classical data defining the instance, such as object geometries and boundary conditions), and/or quantum algorithms for solving optimization problems, such as semidefinite and linear programs (e.g., with applications in logistics and finance, such as using coherent access to the classical matrices defining the optimization problem).

In one or more implementations, the QRAM device 220 may access the classical RAM 218 using an n-qubit address register (e.g., with n qubits 212) that is in a quantum superposition Σₓαₓ|x [symbol] of all 2ⁿ addresses of the memory cells 211 of the classical RAM 218. For simplicity, consider a basic version of QRAM: applying a phase (−1)^{ƒ(x)} onto basis states|x), where the 2ⁿ binary values ƒ(0), ƒ(1), . . . , ƒ(2ⁿ−1) (e.g., where ƒ(x) is a data value of either zero or one that is stored at a location corresponding to the address, x) are stored in the classical RAM 218. In this example, the QRAM operation may be given by:

$${\sum }_{x ∈ {\{ 0 , 1 \}}^{n}} {α}_{x} \vert x 〉 {↦}^{V ( f )} {\sum }_{x ∈ {\{ 0 , 1 \}}^{n}} {( - 1 )}^{f ( x )} {α}_{x} \vert x 〉 . \qquad ( 1 )$$

An n-qubit unitary V(ƒ) that implements this operation for a database ƒ is diagonal in the computational basis, with diagonal ±1 entries determined by the Boolean function ƒ. The controlled V(ƒ) operation can be used to implement a formulation of QRAM, which reads the classical data into an ancilla register as |x [symbol] |0 [symbol] →|x [symbol] ƒ(x) [symbol] . Whereas a single classical RAM query can access at most one entry of a database, a single QRAM query suffices to create a superposition over all 2ⁿ entries.

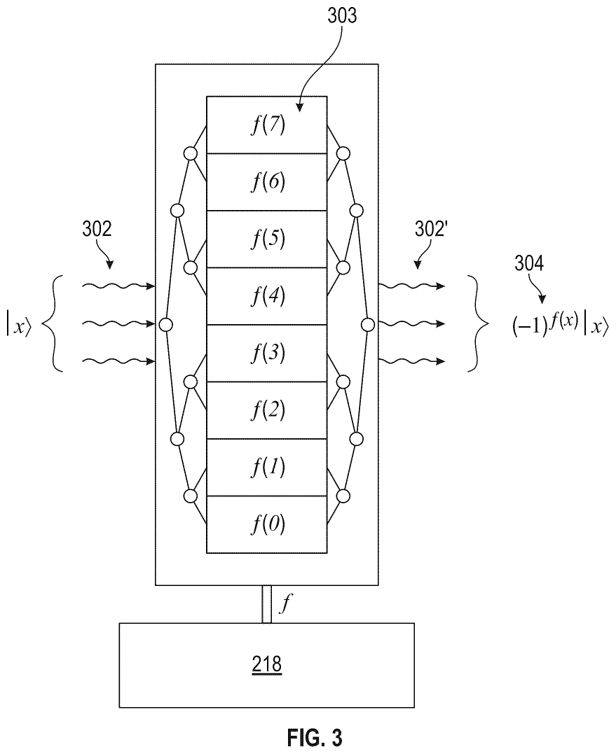

FIG. 3 schematically illustrates a passive QRAM device 300 that may be used to access the data stored in the classical RAM 218. For example, the passive QRAM device 300 may be specialized for QRAM and configured to perform the QRAM operation passively and ballistically, (e.g., automatically by natural evolution of the system while requiring at most poly(n) external interventions from classical control and dissipating at most poly(n) energy). For example, the passive QRAM device 300 may encode the address state Σₓαₓ|x [symbol] into the polarization states of n photons 302, and then send the photons 302 into a pre-manufactured device (e.g., QRAM device 300) from which the photons 302′ return having picked up a phase 304 of −1 only on branches of the superposition where the data ƒ(x)=1. For example, the classical bits ƒ(0), ƒ(1), . . . , ƒ(2ⁿ−1) may be placed, by the pre-manufactured device at the leaves 303 of a binary tree, selectively routing the photons 302 to the right leaf based on their polarization, picking up a phase if a photon exists at location x and ƒ(x)=1, and then un-routing the n photons. The polarizations of the photons 302′ may (e.g., with some noise or errors) correspond to the addresses (e.g., x) of the classical bits ƒ(0), ƒ(1), . . . , ƒ(2ⁿ−1).

In one or more implementations of the subject technology, the passive QRAM device 300 may form a part of the QRAM device 220 of FIG. 2. For example, the passive QRAM device 300 may be used to perform a preparation operation of the distillation-teleportation operation as described in further detail hereinafter (e.g., the quantum superposition of the polarization states of the photons 302′ may be used as a prepared quantum state, |Ψ(ƒ) [symbol] (Ψ(ƒ)|, in a distillation-teleportation operation, as discussed in further detail hereinafter), and (as described in further detail hereinafter) the qubits 212 and 215 of the QRAM device 220 may be used to perform encoding, distillation, and teleportation operations that generate classical n-bit measurement outcomes, which may be sent to the classical processor 200 to perform a classical update rule to update the dataset stored in the classical RAM 218 (which can then be queried by the QRAM device 300 for a next round of the protocol).

In one or more other implementations, the QRAM device 220 of FIG. 2 may be the passive QRAM device 300 of FIG. 3. In these other implementations, the QRAM device 220 may be used to perform the preparation operation to create QRAM resource states on n physical qubits, which may then be moved onto the quantum processor 202 (e.g., qubits 210 of the quantum processor 202). In these other implementations, the quantum processor 202 may then encode, distill, and teleport these resource states, generating the classical n-bit measurement outcomes, which may then be sent from the quantum processor 202 to the classical processor 200 to perform the classical update rule to update the dataset stored in the classical RAM 218 (which can then be queried by the QRAM device 220 for a next round of the protocol).

Even with a passive QRAM device 300, for fault-tolerant quantum computation, the ability to apply the physical QRAM operation at computational cost poly(n) may not be sufficient to justify a cheap QRAM assumption, even if there are no errors in the QRAM device itself. This challenge originates from the fact that, due to inevitable noise in the main quantum processor, quantum computations will need to be performed fault tolerantly.

In fault-tolerant quantum computation (FTQC), quantum information is processed within a quantum error-correcting (QEC) code, and the goal is then to implement the logical QRAM operation, denoted V̅(̅ƒ̅)̅, on the encoded data. The passive QRAM device 300 would implement the physical QRAM operation V(ƒ), not the logical V̅(̅ƒ̅)̅. Naively, we might implement V̅(̅ƒ̅)̅ by un-encoding the n logical qubits into n physical qubits, running the physical qubits through the passive QRAM device, and re-encoding the output. However, the un-encoding and re-encoding processes cannot be fault tolerant, and furthermore any errors in the passive QRAM device 300 will turn into logical errors on the re-encoded state. As a result, a purely passive QRAM device strategy does not implement V(ƒ) fault tolerantly. Said another way, each application of V̅(̅ƒ̅)̅ within the quantum algorithm incurs some non-negligible probability of logical error, proportional to the physical error rate of the main processor and any error in the passive QRAM device itself, limiting the number of times QRAM can be applied within any computation. A potential workaround would be to find a QEC code where the logical V̅(̅ƒ̅)̅ is a transversal gate, meaning it can be implemented as a tensor product of poly(n) physical V (ƒ) gates without the need for un-encoding and re-encoding. Unfortunately, there are known barriers to such codes. For example, already for n=3 and a certain choice of ƒ, V (ƒ) is equal to the CCZ gate, which is equivalent to the Toffoli gate up to conjugation by Hadamard. However, Toffoli does not admit a transversal implementation. Relatedly, CCZ and Hadamard together form a universal gate set and thus are not both transversal in the same code.

In accordance with aspects of the subject disclosure, a protocol is provided that implements the logical operation V̅(̅ƒ̅)̅ fault tolerantly, using poly(n) queries to a noisy physical QRAM operation. The protocol generalizes distillation-teleportation protocols for non-Clifford gates like the T gate and the CCZ gate. For example, as discussed in further detail hereinafter, the protocol may first use the physical V(ƒ) gate (e.g., using a passive QRAM device, such as the passive QRAM device 300) to prepare many copies of a faulty physical QRAM resource state. The physical resource states may then be encoded into respective QEC codes (e.g., a surface code, a color code, or other QEC) and those encoded states can then be distilled into a single high-fidelity logical resource state. The high-fidelity logical resource state may then be teleported into the computation to enact the logical QRAM gate, up to a correction which can be computed classically. The correction may be a different logical QRAM gate V̅(̅g̅)̅, where g is determined based on ƒ and random measurement outcomes obtained during the teleportation procedure. The correction V̅(̅g̅)̅ may then be implemented in the same way as the logical operation V̅(̅ƒ̅)̅, resulting in a correction of its own, V̅(̅h̅)̅, where h is again dependent on g and random measurement outcomes. After n rounds, no further correction is necessary. This is a consequence of the fact that V(ƒ) lies in the n-th level of the Clifford hierarchy, which implies that the first correction V(g) is in the (n−1)-th level, the second correction V(h) is in the (n−2)-th level, and so on. Accordingly, at most n rounds are required to fully descend the hierarchy. As discussed in further detail hereinafter, (i) these corrections lie within the family of QRAM gates of Eq. (1) above, allowing for a straightforward recursive implementation, and (ii) a method is provided for preparing the encoded resource states, resulting in a complete end-to-end workflow for fault-tolerant V̅(̅ƒ̅)̅.

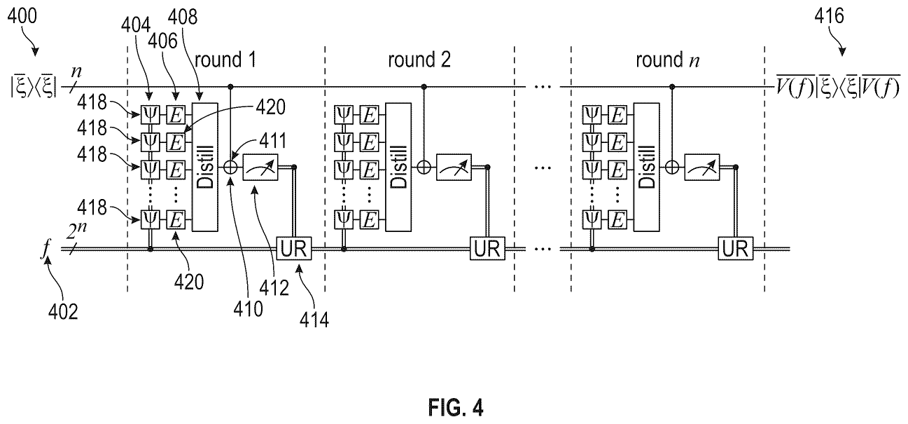

For example, FIG. 4 is a quantum circuit depiction of a protocol for implementing the logical diagonal QRAM operation V̅(̅ƒ̅)̅ fault tolerantly for a data table f. As shown, the protocol cycles through, for example, n rounds, and each round has five steps: preparation 404, encoding 406, distillation 408, quantum teleportation 410, and classical update 414. All gates in FIG. 4 are fault-tolerant, logical gates, except a faulty QRAM oracle [symbol] and an encoding [symbol] . FIG. 4 includes solid wires representing encoded logical quantum registers, solid wires between the preparation 404 and encoding 406 that represent unencoded physical quantum registers, and double black lines that represent classical registers.

As shown in FIG. 4, in the first round (round 1) in FIG. 4, the data 402 (e.g., ƒ(x)) from the classical RAM 218 is used to prepare multiple copies or versions (e.g., using multiple applications of a quantum oracle 418 to the data ƒ(x)) of a first quantum state (e.g., Ψ=|Ψ(ƒ) [symbol] Ψ(ƒ)|). For example, various versions of the first quantum state Ψ may be prepared with various different (e.g., unintentional and/or random) errors. The multiple versions of first quantum state may be generated in parallel by multiple quantum oracles 418 (e.g., multiple instances of the passive quantum RAM device 300) or by repeated operations of a single quantum oracle (e.g., a single passive quantum RAM device 300). Implementations in which a quantum computing system is provided with multiple quantum oracles 418 may have a large physical footprint, but may be able to perform the teleportation-distillation protocol faster than in quantum computing systems that instead use repeated operations of single quantum oracle 418.

As shown in FIG. 4, each of these (e.g., noisy, such as including errors) versions of the first quantum state |Ψ(ƒ) [symbol] Ψ(ƒ)| may then be encoded into a respective encoded first quantum state (e.g., |̅Ψ̅(̅ƒ̅)̅ [symbol] Ψ̅(̅ƒ̅)̅|̅, which may also include one or more errors resulting from the errors in the versions of the first quantum state |Ψ(ƒ) [symbol] Ψ(ƒ)| and/or resulting from the encoding operation). For example, each of the versions of the first quantum state |Ψ(ƒ) [symbol] Ψ(ƒ)| may be encoded into a respective encoded first quantum state |̅Ψ̅(̅ƒ̅)̅ [symbol] Ψ̅(̅ƒ̅)̅|̅ by applying an encoding isometry 420 (denoted with an E in the figure) to the each of the versions of the first quantum state |Ψ(ƒ) [symbol] Ψ(ƒ)|. For example, the encoding isometry may map physical states into their respective encoded states. The encoding isometry may be injective, and its image may be known as the codespace of the encoding. As shown, the multiple versions of the encoded first quantum state |̅Ψ̅(̅ƒ̅)̅ [symbol] Ψ̅(̅ƒ̅)̅|̅ may then be distilled into a single distilled quantum state |̅Ψ̅(̅ƒ̅)̅ [symbol] Ψ̅(̅ƒ̅)̅|̅ to reduce or eliminate the errors resulting from the preparation and/or encoding operations. The quantum teleportation 410 may be performed on the distilled quantum state using one or more quantum logical CNOT gates 411 (e.g., represented as a single quantum logical CNOT gate 411 in FIG. 4 for simplicity). For example, the quantum logical CNOT gates 411 may be controlled using another quantum state 400 (e.g., |Σ̅ [symbol] \hat{Σ}| in the figure). For example, the quantum state |Σ̅ [symbol] \hat{Σ}| in FIG. 4 may correspond to:

$${\sum }_{x ∈ {\{ 0 , 1 \}}^{n}} {α}_{x} \vert x 〉 ,$$

in Eq. (1) above (e.g., which may be stored in an address register, such as an address register of the QRAM device 220, using the qubits 212). In this way, the single distilled quantum state from the distillation operation 408 may be teleported to one or more data qubits (e.g., implemented using qubits 215).
In an illustrative example, the intended teleported state may be an equal superposition over all computational basis states |x [symbol] of the address registers, with the signs of each state |x [symbol] in the superposition determined by the values of the data ƒ(x) in the classical RAM 218 (e.g., Σₓαₓ(−1)^{ƒ(x)}|x [symbol] , as in Eq. (1) above). However, even after distilling out some or all of the random errors in the multiple versions of the encoded first quantum state |̅Ψ̅(̅ƒ̅)̅ [symbol] Ψ̅(̅ƒ̅)̅|̅ , the intended phase (−1)^{ƒ(x)} may be incorrectly applied onto the basis state |x⊕m [symbol] rather than the intended basis state |x [symbol] , where m corresponds to these additional errors and varies in each round of the protocol. Due to these additional errors, the teleported quantum state in round 1 may be Σₓαₓ(−1)^{ƒ(x⊕m)}|x [symbol] instead of the intended Σₓαₓ(−1)^{ƒ(x)}|x [symbol] .

As shown in FIG. 4, following the teleportation 410, a measurement operation 412 may then be performed to obtain a classical measurement result (e.g., m) of the quantum teleportation operation 410. As shown, the classical measurement result may be provided to the classical update 414 for use in determining a new data set, g, to be used to prepare multiple copies of a second quantum state for round 2. For example, the new data set, g, may be:

$$g ( x ) = f ( x ) ⊕ f ( x ⊕ m ) , \qquad ( 2 )$$

including a term (e.g., ƒ(x ⊕m)) for undoing the errors of the prior round, and a term (e.g., ƒ(x)) to re-apply the correct dataset, ƒ.

As shown, after repeating this protocol for multiple (e.g., n or less than n) rounds, the desired quantum state 416

$$( e . g . , \overline{V ( f )} \vert \overline{ξ} 〉 \vert \overline{ξ} 〉 \overline{V ( f )} ,$$

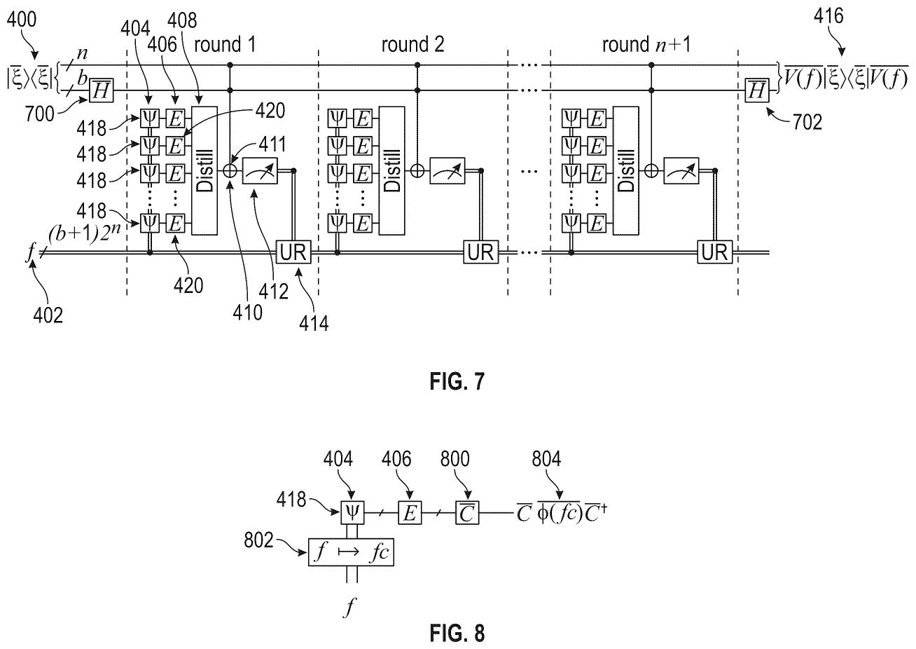

which may be the quantum superposition (Σₓαₓ(−1)ƒ(x)|x [symbol] of additional quantum states (|x⇄) that are each based on one of the classical data bits (ƒ(x)) from the classical RAM 218), has been teleported to the data qubits (e.g., for use in a subsequent quantum computation). In the example of FIG. 4, data bits are stored at n addresses, and a n-qubit address register is described. However, it is appreciated that multiple bits may be stored at each address, and an n-qubit address register and a b-qubit bus register may be used in the protocol (e.g., as discussed in further detail hereinafter in connection with FIG. 7).

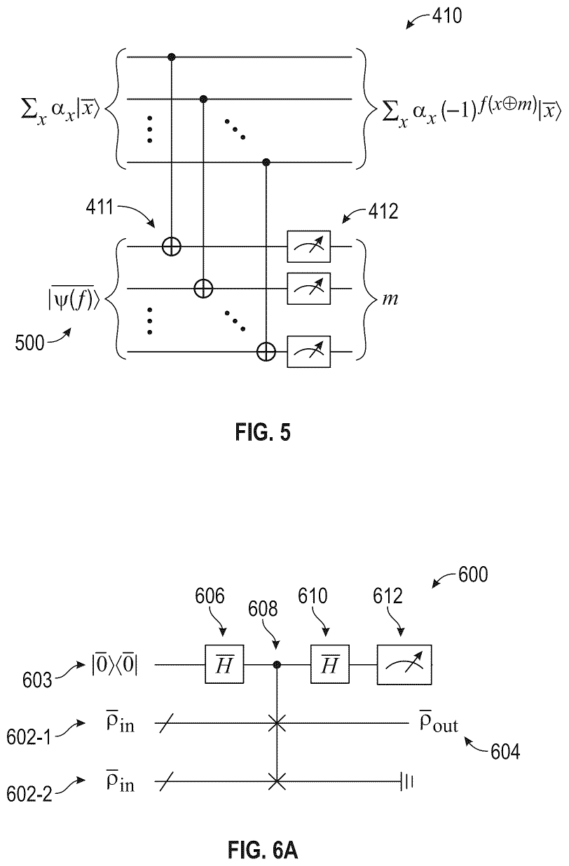

FIG. 5 is a quantum circuit diagram showing an example of a quantum teleportation operation, which may be implemented as the quantum teleportation 410 discussed herein. In the example of FIG. 5, a high-fidelity logical resource state 500 may have been generated by the distillation operation 408 of FIG. 4. In this example, n logical quantum CNOT gates 411 are applied in which each of the n qubits (e.g., logical qubits) in the address state (e.g., |̅Σ̅ [symbol] Σ̅|̅ or Σαₓ|x [symbol] ) targets a corresponding one of the n qubits (e.g., logical qubits) in the high-fidelity logical resource state 500. In this way, the n qubits of the address state may be entangled with the n qubits of the high-fidelity logical resource state 500. In this way, the quantum teleportation 410 may quantum teleport the information (e.g., the phases (−1)^{ƒ(x⊕m)} in round 1) in the high-fidelity logical resource state 500 into the phases of the address state.

As shown in FIG. 5, a measurement operation 412 may be performed for following the logical quantum CNOT gate 411 for each logical qubit in the high-fidelity logical resource state 500 to obtain the error values m. As discussed above in connection with FIG. 4, these error values, m, may then be used to generate the new inputs (e.g., g(x)=ƒ(x)⊕ƒ(x⊕m)) to the preparation operation 404 for the next round.

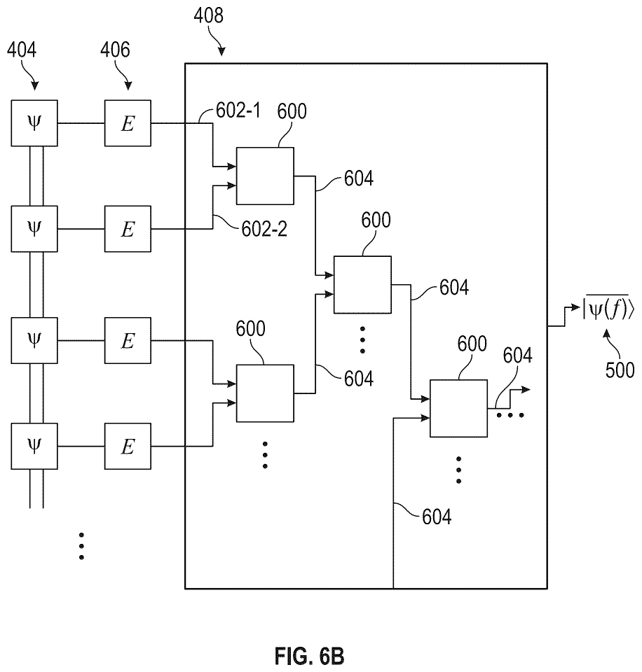

The distillation operation 408 may include one or more quantum purity amplifications, such as swap test purification operations or other quantum purity amplifications. FIG. 6A is a quantum circuit diagram showing an example of a swap test purification operation 600 that can be used in the distillation operation 408. FIG. 6A illustrates the swap test purification operation 600 for a general quantum state ρ̅ᵢₙ, which may represent one of the encoded resource states, |̅Ψ̅(̅ƒ̅)̅ [symbol] Ψ̅(̅ƒ̅)̅|̅ , from the encoding operation 406 of FIG. 4. In this example, two versions 602-1 and 602-2 of the same input state ρ̅ᵢₙ (e.g., two versions of the state |̅Ψ̅(̅ƒ̅)̅ [symbol] Ψ̅(̅ƒ̅)̅|̅ are provided to the swap test purification operation 600 along with a state 603. For example, the multiple versions of the input state ρ̅ᵢₙ may be the multiple results of the encoding operations 406 of FIG. 4. As shown, the result of applying a Hadamard gate 606 to the state 603 is used to control a controlled swap gate 608 to generate an output state 604 (e.g., by swapping or not swapping the two versions 602-1 and 602-2 of the same input state ρ̅ᵢₙ based on the control state). Following the controlled swap gate 608, a Hadamard gate 610 is applied to the result of applying the Hadamard gate 606, and a measurement 612 is made. The output state 604 may be accepted (e.g., and fed to a subsequent iteration of the swap test purification operation, or used as the distilled state output of the distillation operation 408) or discarded based on the measurement 612. For example, if the qubit initially in state |0 [symbol] 0| is measured to be in state |0 [symbol] 0|, the swap test may be passed, and the output state 604 may be accepted.

As shown in FIG. 6B, multiple instances of the swap test purification operation 600 may be applied to multiple pairs of the encoded states from the encoding operation 406. The swap test purification operations 600 may be iterated by feeding pairs of passing outputs 604 of preceding swap test purification operations 600 to subsequent instances of the swap test purification operation 600 until the high-fidelity logical resource state 500 is generated as an output 604 of a final swap test purification operation 600 of the distillation operation 408 (e.g., and provided to the quantum teleportation operation 410).

In the example of FIG. 6B, the encoded states are generated in parallel by the encoding operations 406, and the swap test purification operations 600 are performed in a cascading tree. However, this is merely illustrative and other arrangements of the distillation operation 408 are contemplated. For example, in implementations in which fewer (e.g., one or two) passive QRAM devices 300 are provided, the comparisons performed by the swap test purification operations 600 may be performed on each pair of encoded states when the encoded states are generated, and the output state resulting from the swap test comparison may be compared with a new encoded state generated after the prior comparison.

By performing the logical V̅(̅ƒ̅)̅ using poly(n) calls to physical QRAM, the disclosed protocol salvages the utility of the passive QRAM device 300, and implements a model of quantum computation where QRAM is performed separately from the main quantum processing unit.

The disclosed protocol also at least partially justifies the “cheap QRAM assumption” (e.g., that, for an arbitrary dataset ƒ, the computational cost of implementing unitary operation V (ƒ) from Eq. (1) above is poly(n)). Indeed, for a noisy passive QRAM with a computational cost poly(n), the quantum resources required to implement fault-tolerant QRAM also scales only as poly(n). Running the disclosed protocol utilizes a non-negligible amount of adaptive classical computation of complexity poly(n) 2ⁿ to compute the correction operations (e.g., and reload the passive QRAM device with a new classical dataset between each query), although this complexity may be amenable to some degree of parallelization.

In some implementations, the disclosed protocol may be viewed as trading O(2ⁿ) quantum resources for O(2ⁿ) classical resources. That is, the disclosed protocol does not require the O(2ⁿ) actively error-corrected quantum resources incurred in circuit QRAM (e.g., fault-tolerant quantum gates, ancilla qubits, magic state factories, control wiring, classical co-processors, etc.). Instead, the disclosed protocol utilizes poly(n) 2ⁿ purely classical resources in addition to only poly(n) fault-tolerant quantum resources and poly(n) queries to a passive physical QRAM device. In various use cases, this tradeoff is beneficial, since quantum devices can be slower and more expensive than classical devices for some purposes.

As noted above in connection with FIG. 4, in some implementations, data bits are stored at 2ⁿ addresses, and a n-qubit address register is described. FIG. 7 illustrates a quantum circuit diagram showing the quantum-distillation protocol of FIG. 4 in an implementation in which multiple bits may be stored at each address. As shown in FIG. 7, an n-qubit address register and a b-qubit bus register may be used in the protocol. For example, a Hadamard gate 700 may be applied to the b-qubit bus register prior to the first round of the distillation-teleportation protocol (e.g., prior to controlling the logical quantum CNOT gates 411 using the n-qubit address register and a b-qubit bus register), and a Hadamard gate 702 may be applied to the b-qubit bus register after the last round of the distillation-teleportation protocol. In this example, each quantum oracle 418 may include a faulty physical QRAM oracle including a family of quantum operations that take, as input, a classical description of a signed n-bit function with b output bits, and produces a physical quantum state Y′ on n+b physical qubits.

In one or more implementations, a partial Clifford twirling operation may be added to the distillation-teleportation protocol (e.g., to effectively randomize the data being queried, such as to remove any dependence on the data, ƒ, from the average noise channel). For example, FIG. 8 illustrates a quantum circuit diagram showing how a partial Clifford twirling operation 800 may be performed between the encoding 406 and the distillation 408 in either of FIG. 4 or 7.

In the example of FIG. 8, prior to (e.g., prior to each instance, in each round of) a quantum oracle 418 (e.g., passive QRAM device 300) being called to generate a physical resource state, a twirling gate C may be randomly generated by generating from of a subset of the Clifford gates (e.g., by generating a product of gates selected from of a subset of the Clifford gates). For example, the subset of the Clifford gates may include the single-qubit Pauli-Z gate, the controlled-Z (CZ) gate, the Pauli-X gate, and the controlled-X (CX or CNOT) gate (e.g., excluding the Hadamard and phase gates that are part of the full set of Clifford gates, as these gates do not map QRAM unitaries to QRAM unitaries). For example, the partial Clifford twirling operation may be referred to as “partial” due to the exclusion of the Hadamard and phase gates in the generation of the twirling gate C. For example, each randomly generated twirling gate C may be a product of O(n) single-qubit Pauli-Z gates, O(n²) CZ gates, O(n) Pauli-X gates, and O(n²) CX gates.

Once a twirling gate C has been chosen (e.g., and prior to generation of the physical resource state by the quantum oracle 418), a data update operation 802 may be performed to modify the data ƒ(x), based on the chosen twirling gate C, as follows:

$${f}_{C} ( x ) = f ( Ax ⊕ u ) ⊕ [ x \cdot v ] ⊕ [ {x}^{T} Bx ] , \qquad ( 3 )$$

where A, u, v, and B are parameters (e.g., values and/or matrices of values) used in the generation of the twirling gate C. For example, the data update operation 802 may replace the data, ƒ (e.g., in the classical RAM 218), at each address x with the data ƒ_{C} of Eq. (3).

In one or more examples, the state generated by the preparation 404 and the encoding 406 of FIG. 4 or 7 may be denoted as φ̅(̅ƒ̅)̅. As discussed herein, the preparation 404 and the encoding 406 may generate many versions of φ̅(̅ƒ̅)̅. Applying the twirling gate C after modifying the data (with data update operation 802) based on the twirling gate C (e.g., and after state preparation 404 and encoding 406) generates an encoded state 804 (e.g., C̅φ̅(̅ƒ̅_̅{̅C̅}̅)̅C̅|̅ . For example, because the data was updated, based on the twirling gate and prior to application of the twirling gate, the average (e.g., over the random choice of C) of the encoded state C̅φ̅(̅ƒ̅_̅{̅C̅}̅)̅C̅|̅ may be φ̅(̅ƒ̅)̅_{twirl}, in which the original data, ƒ (e.g., from prior to the data update operation 802), is restored while ensuring that φ̅(̅ƒ̅)̅_{twirl} has |̅Ψ̅(̅ƒ̅)̅ as its principal eigenvector (e.g., so that the distillation 408 can successfully distill |̅Ψ̅(̅ƒ̅)̅ [symbol] Ψ̅(̅ƒ̅)̅|̅ from the many versions of φ̅(̅ƒ̅)̅. In one or more implementations, the partial Clifford twirling operation 800 and the data update operation 802 may be omitted (e.g., in implementations in which the passive QRAM device 300 already results in φ̅(̅ƒ̅)̅ having |̅Ψ̅(̅ƒ̅)̅)̅ as its principal eigenvector).

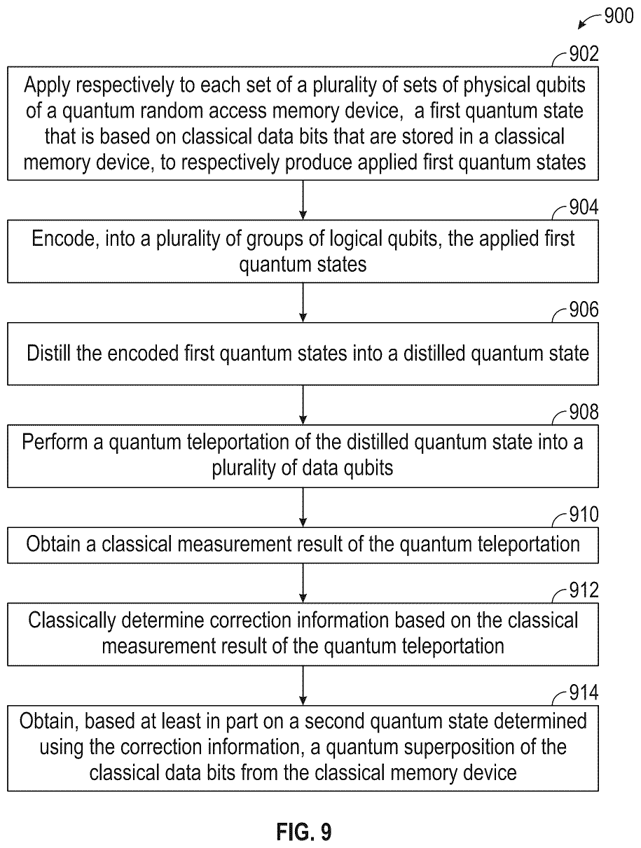

FIG. 9 illustrates a flow diagram of an exemplary process for a distillation-teleportation protocol for fault-tolerant QRAM, in accordance with one or more embodiments of the subject technology. For explanatory purposes, the process 900 is primarily described herein with reference to FIGS. 1-3. However, the process 900 is not limited to the items shown in FIGS. 1-3, and one or more blocks (or operations) of the process 900 may be performed by one or more other components of other suitable devices. Further, for explanatory purposes, the blocks of the process 900 are described herein as occurring serially or linearly. However, multiple blocks of the process 900 may occur in parallel. In addition, the blocks of the process 900 need not be performed in the order shown and/or one or more blocks of the process 900 need not be performed and/or may be replaced by other operations.

At block 902, a plurality of applications (e.g., preparations generated by the preparation operation 404) of a first quantum state (e.g., Ψ, or |̅Ψ̅(̅ƒ̅)̅ [symbol] Ψ̅(̅ƒ̅)̅|̅ , which may be an unencoded physical n-qubit quantum state) may be performed. The first quantum state may be based on classical data bits (e.g., ƒ(x)) that are stored in a classical memory device (e.g., classical RAM 218). For example, the first quantum state may be applied to each set of a plurality of sets of physical qubits (e.g., qubits 212) of a quantum random access memory device (e.g., QRAM device 220). Application of the first quantum state to each set of the plurality of physical qubits, may respectively produce an applied first quantum state.

Each applied first quantum state (e.g., the first quantum state as applied to each set of the plurality of sets of physical qubits) may include at least one error component. For example, when applied to (e.g., prepared in) a set of physical qubits, the resulting applied first quantum state may be a state that is different from the intended state |̅Ψ̅(̅ƒ̅)̅ [symbol] Ψ̅(̅ƒ̅)̅|̅ due to one or more physical errors in the preparation/application process.

At block 904, the applied first quantum states (e.g., multiple noisy states |̅Ψ̅(̅ƒ̅)̅ [symbol] Ψ̅(̅ƒ̅)̅|̅)̅ with various errors relative to the ideal version of |̅Ψ̅(̅ƒ̅)̅ [symbol] Ψ̅(̅ƒ̅)̅|̅)̅ (e.g., as applied, respectively, to the plurality of sets of physical qubits) may be encoded (406), into a plurality of groups of logical qubits to respectively produce encoded first quantum states (e.g., resulting in multiple encoded first quantum states |̅Ψ̅(̅ƒ̅)̅ [symbol] Ψ̅(̅ƒ̅)̅|̅ with errors). For example, the encoded first quantum states |̅Ψ̅(̅ƒ̅)̅ [symbol] Ψ̅(̅ƒ̅)̅|̅)̅ (e.g., as encoded into each group of the plurality of groups of logical qubits) may include at least one additional error component. Each group of the plurality of groups of logical qubits may utilize a second respective set of the physical qubits (e.g., each second set larger than the corresponding first set) of the quantum random access memory device.

At block 906, the encoded first quantum states (e.g., multiple states |̅Ψ̅(̅ƒ̅)̅ [symbol] Ψ̅(̅ƒ̅)̅|̅ with errors) may be distilled (406) (e.g., from the plurality of groups of logical qubits) into a distilled quantum state (e.g., a single distilled quantum state |̅Ψ̅(̅ƒ̅)̅ [symbol] Ψ̅(̅ƒ̅)̅|̅ , denoted using |̅Ψ̅(̅ƒ̅)̅)̅ in the examples of FIGS. 5, 6A, and 6B). For example, distilling the encoded first quantum states in the plurality of groups of logical qubits into the distilled quantum state may include iteratively performing a series of swap test purification operations 600 (see, e.g., FIG. 6B) that each receive the encoded first quantum states in the plurality of groups of logical qubits as inputs (e.g., as discussed herein in connection with FIG. 6A). The distilled quantum state may be free of the at least one error component and the additional error component.

In one or more implementations, after encoding the applied first quantum states at block 904 and prior to distilling the encoded first quantum states at block 906, the process 900 may include performing a partial Clifford twirling operation (e.g., including partial Clifford twirling 800 and data update operation 802 of FIG. 8) on the encoded first quantum states.

At block 908, a quantum teleportation (410) of the distilled quantum state into a plurality of data qubits (e.g., qubits 215) may be performed (e.g., as discussed herein in connection with FIG. 5). In various implementations, the data qubits may be included in the quantum random access memory device or may be separate from the quantum random access memory device.

At block 910, a classical measurement result (e.g., m, which may be a string of n binary values, such as zero or one) of the quantum teleportation may be obtained (e.g., using measurement operation 412, such as by consuming the resource sate |̅Ψ̅(̅ƒ̅)̅)̅ by measuring each of the n qubits of the resource state). In one or more implementations, performing the quantum teleportation at block 908 may include applying, to each group of the plurality of groups of logical qubits, a respective group of quantum logical controlled-NOT (CNOT) gates (e.g., quantum logical CNOT gates 411), in which each of the quantum logical CNOT gates (i) targets a corresponding one of the logical qubits that store the distilled quantum state and (ii) is controlled based on an additional quantum state (e.g., |Σ̅ [symbol] Σ̅ in FIG. 4 or Σαₓ|x [symbol] in FIG. 5) initially stored by the data qubits. In these implementations, the classical measurement result may include a group of measurements (e.g., m) of a group of outputs of the group of quantum logical CNOT gates (e.g., as shown in FIG. 4 and FIG. 5) (e.g., a group of measurements of the targets of the group of quantum logical CNOT gates).

At block 912, correction information (e.g., ƒ(x)⊕ƒ(x⊕m), where ⊕ represents a bit-wise addition modulo 2) may be determined (414) (e.g., classically, using classical computing resources, such as the classical processor 200) based on the classical measurement result of the quantum teleportation (e.g., by updating ƒ to g=ƒ(x)⊕ƒ(x⊕m)). For example, determining the correction information based on the classical measurement result of the quantum teleportation may include computing (e.g., modulo 2) a first bitwise sum (e.g., x⊕m) of a plurality of address bits (x) of the classical memory device and a plurality of corresponding values (m) of the classical measurement result, and (e.g., modulo 2) a second bitwise sum (e.g., ƒ(x)⊕ƒ(x⊕m)) of a plurality of the classical data bits (ƒ(x)) at a plurality of first addresses corresponding to the plurality of address bits (x) and a plurality of the classical data bits (ƒ(x) m)) at a plurality of second addresses corresponding to the first bitwise sum (x⊕m) (e.g., using a classical update rule URₘ(g)=g⊕g^{⊕m}).

At block 914, a quantum superposition of the classical data bits (e.g., ƒ(x)) from the classical memory device may be obtained (e.g., the classical data bits may be simultaneously obtained in superposition), based at least in part on a second quantum state (e.g., |̅Ψ̅(̅h̅)̅ [symbol] Ψ̅(̅h̅)̅|̅)̅ or an updated |̅Ψ̅(̅g̅)̅ [symbol] Ψ̅(̅g̅)̅|̅ in which updated g is updated using the correction information) determined using the correction information.

For example, obtaining the quantum superposition of the classical data bits from the classical memory device may include storing, as the obtained quantum superposition of the classical data bits, a subsequent quantum teleportation (e.g., V̅(̅ƒ̅)̅ [symbol] V̅(̅ƒ̅)̅)̅ of a subsequent distilled quantum state (e.g., |̅Ψ̅(̅ƒ̅)̅ [symbol] Ψ̅(̅ƒ̅)̅|̅) in the plurality of data qubits. For example, the subsequent quantum teleportation of the subsequent distilled quantum state may include an error-free superposition (e.g., Σₓαₓ(−1)^{ƒ(x)|x} [symbol] ^{) of additional quantum states (e.g., |x)) that are each based on one of the classical data bits (e.g., ƒ(x)) from the classical memory device.}

In one or more implementations, the process 900 may also include performing, with a quantum processor (e.g., quantum processor 202) separate from the quantum random access memory device, a quantum computation (e.g., a quantum machine learning algorithm, a quantum algorithm for solving a differential equations, and/or a quantum algorithm for solving an optimization problem (e.g., for semidefinite and linear programs, such as for logistics and/or finance) using the stored subsequent quantum teleportation of the subsequent distilled quantum state.

In one or more implementations, one or more additional rounds (e.g., round 2 through round n) of the operations of blocks 902-914 may be performed (e.g., as described in connection with FIG. 4). For example, obtaining the quantum superposition, based at least in part on the second quantum state determined using the correction information, of the classical data bits from the classical memory device may include (e.g., for a second round of the operations of blocks 902-914) applying, to each set of the plurality of sets of physical qubits of the quantum random access memory device, a second quantum state (e.g., |Ψ(ƒ(x)⊕ƒ(x⊕m [symbol] Ψ(ƒ(x)⊕ƒ(x⊕m)|), in which the second quantum state is based on the correction information and the classical data bits that are stored in the classical memory device. Applying the second quantum state to each set of the plurality of sets of physical qubits may respective produce an applied second quantum state. The applied second quantum states (e.g., as applied, respectively, to the plurality of sets of physical qubits) may be encoded into the plurality of groups of logical qubits. The encoded second quantum states (e.g., from the plurality of groups of logical qubits) may be distilled into a second distilled quantum state. A quantum teleportation of the second distilled quantum state into a plurality of data qubits may be performed. A second classical measurement result (m⁽²⁾) of the quantum teleportation of the second distilled quantum state may be obtained. Second correction information may be determined, using the classical computing resources, based on the second classical measurement result of the quantum teleportation. Obtaining the quantum superposition may be based at least in part (e.g., by performing third, fourth, and/or more than fourth rounds of the protocol, such as by performing n rounds of the protocol or less than n rounds of the protocol if the correction information, m, indicates no errors for a particular round) on a third quantum state (e.g., a further correction relative to the second quantum state) determined using the second correction information. For example, obtaining the quantum superposition, based at least in part on the third quantum state determined using the second correction information, of the classical data bits from the classical memory device may include: repeating the applying, the encoding, the distilling, the quantum teleportation, and the determining until a classical measurement result (e.g., m) of the quantum teleportation of a subsequent distilled quantum state indicates (e.g., m^{(p)}=0 in the pth round of the protocol) that the quantum teleportation of the subsequent distilled quantum state is error free; and storing the quantum teleportation (̅V̅(̅ƒ̅)̅Σ̅ [symbol] Σ̅V̅(̅ƒ̅)̅)̅ of the subsequent distilled quantum state in the data qubits as the simultaneously obtained classical data bits from the classical memory device.

In one or more implementations, a quantum random access memory device (e.g., classical RAM 218) is provided that includes physical qubits; and control circuitry configured to perform the operations of any of blocks 902-914.

In one or more implementations, a quantum computer (e.g., quantum computing system 108) is provided that includes a quantum processor (e.g., quantum processor 202), a classical memory device (e.g., classical RAM 218) storing classical data bits, a quantum random access memory device (e.g., QRAM device 220) having physical qubits, control circuitry (e.g., QRAM device 220, classical processor 200, and/or drive circuitry 208) configured to perform the operations of any of blocks 902-914.

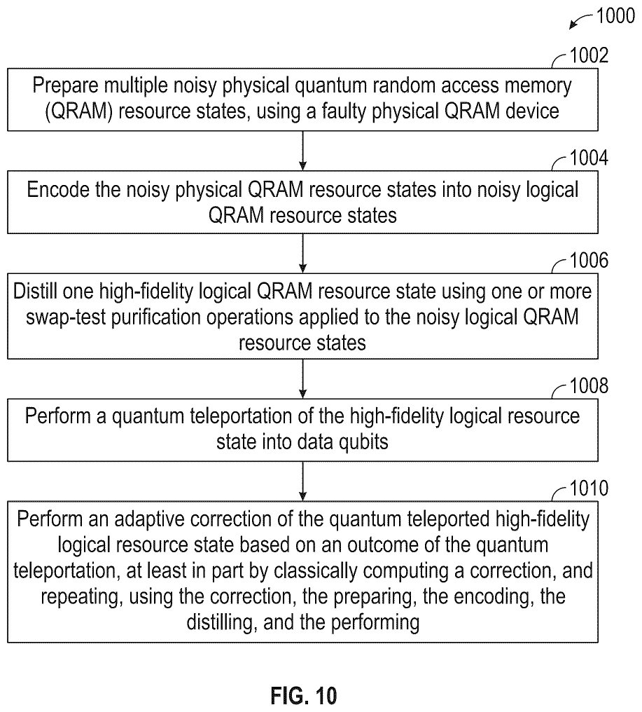

FIG. 10 illustrates a flow diagram of another exemplary process for a distillation-teleportation protocol for fault-tolerant QRAM, in accordance with one or more embodiments of the subject technology. For explanatory purposes, the process 1000 is primarily described herein with reference to FIGS. 1-3. However, the process 1000 is not limited to the items shown in FIGS. 1-3, and one or more blocks (or operations) of the process 1000 may be performed by one or more other components of other suitable devices. Further, for explanatory purposes, the blocks of the process 1000 are described herein as occurring serially or linearly. However, multiple blocks of the process 1000 may occur in parallel. In addition, the blocks of the process 1000 need not be performed in the order shown and/or one or more blocks of the process 1000 need not be performed and/or may be replaced by other operations.

At block 1002, multiple noisy physical quantum random access memory (QRAM) resource states (e.g., Ψ, or |̅Ψ̅(̅ƒ̅)̅ [symbol] Ψ̅(̅ƒ̅)̅|̅)̅ may be prepared (404) using a faulty physical QRAM device (e.g., passive QRAM device 300, which may be, or which may be implemented in the QRAM device 220), such as is discussed herein in connection with FIG. 4 and/or FIG. 7).

At block 1004, the noisy physical QRAM resource states may be encoded (406) into noisy logical QRAM resource states (e.g., |̅Ψ̅(̅ƒ̅)̅ [symbol] Ψ̅(̅ƒ̅)̅|̅ as discussed herein in connection with FIG. 4).

At block 1006, one high-fidelity logical QRAM resource state may be distilled (408) using one or more swap-test purification operations (e.g., swap test purification operations 600 of FIG. 6A) applied to the noisy logical QRAM resource states (e.g., as discussed herein in connection with FIGS. 6A and 6B)).

In one or more implementations, after encoding the noisy physical QRAM resource states at block 1004 and prior to distilling the encoded noisy physical QRAM resource states at block 1006, the process 1000 may include performing a partial Clifford twirling operation (e.g., including partial Clifford twirling 800 and data update operation 802 of FIG. 8) on the encoded first quantum states.

At block 1008, quantum teleportation (410) of the high-fidelity logical resource state into data qubits may be performed (e.g., as discussed herein in connection with FIG. 5).

At block 1010, an adaptive correction (e.g., using classical update 414) of the quantum teleported high-fidelity logical resource state may be performed based on an outcome (e.g., m) of the quantum teleportation, at least in part by classically computing a correction (e.g., g or h in some examples discussed herein), and repeating, using the correction, the preparing, the encoding, the distilling, and the performing of blocks 1002-1010 (e.g., in second, third, and/or more rounds, such as up to n rounds, as discussed herein in connection with FIGS. 4, 7, and/or 8).

In one or more implementations, a quantum random access memory device (e.g., quantum RAM 220) is provided that includes physical qubits; and control circuitry configured to perform the operations of any of blocks 1002-1010.

In one or more implementations, a quantum computer (e.g., quantum computing system 108) is provided that includes a quantum processor (e.g., quantum processor 202), a classical memory device (e.g., classical RAM 218) storing classical data bits, a quantum random access memory device (e.g., QRAM device 220) including physical qubits, control circuitry (e.g., QRAM device 220, classical processor 200, and/or drive circuitry 208) configured to perform the operations of any of blocks 1002-1010.

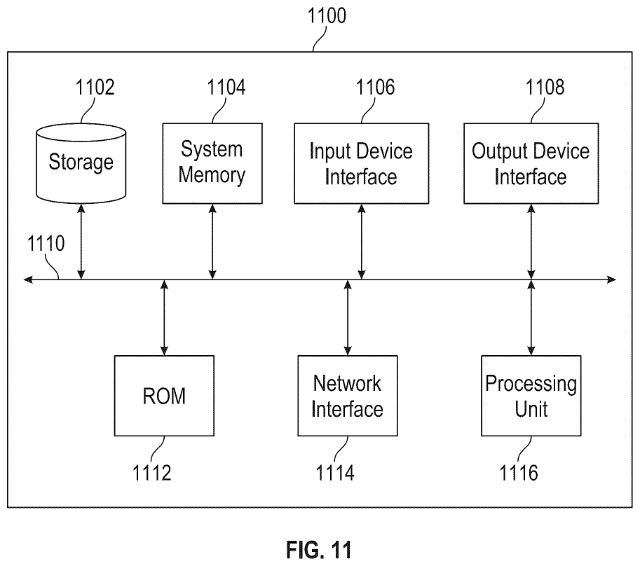

FIG. 11 illustrates an example electronic system 1100 in which aspects of the present disclosure may be implemented, in accordance with one or more embodiments of the subject technology. The electronic system 1100 may be, and/or may be a part of, a computing device (e.g., client devices 102, server(s) 106, and/or quantum computing systems 108). The electronic system 1100 may include various types of computer-readable media and interfaces for various other types of computer-readable media. The electronic system 1100 may include a bus 1110, a storage device 1102, a system memory 1104, an input device interface 1106, an output device interface 1108, a ROM 1112, a network interface 1114, and a processing unit 1116, or subsets and variations thereof. Not all depicted components may be used in all embodiments, however, and one or more embodiments may include additional or different components than those shown in the figure. Variations in the arrangement and type of the components may be made without departing from the spirit or scope of the claims as set forth herein. Additional components, different components, or fewer components may be provided.

Network interface 1114 may be configured to allow data to be exchanged between the electronic system 1100 and devices attached to a network or networks (e.g., network 104), such as other computer systems or devices. In various embodiments, network interface 1114 may support communication via any suitable wired or wireless general data networks, such as types of Ethernet networks, for example. Additionally, network interface 1114 may support communication via telecommunications/telephony networks, such as analog voice networks or digital fiber communications networks, via storage area networks such as Fiber Channel SANs (storage area networks) or via any other suitable type of network and/or protocol.

The bus 1110 collectively represents all system, peripheral, and chipset buses that communicatively connect the numerous internal devices of the electronic system 1100. In one or more embodiments, the bus 1110 communicatively connects the processing unit 1116 with the other components of the electronic system 1100 (e.g., the ROM 1112, the system memory 1104, and the persistent storage device 1102). From various memory units, the processing unit 1116 retrieves instructions to execute and data to process in order to execute the operations of the subject disclosure. The processing unit 1116 may be a controller and/or a single- or multi-core processor or processors in various embodiments.

The ROM 1112 may store static data and instructions that are needed by the one or more processing unit(s) 1116 and other modules of the electronic system 1100. The storage device 1102, on the other hand, may be a read-and-write memory device. The storage device 1102 may be a non-volatile memory unit that stores instructions and data (e.g., static and dynamic instructions and data) even when the electronic system 1100 is off. Data may include one or more long-term data stores (e.g., databases). In one or more embodiments, a mass-storage device (such as a magnetic or optical disk and its corresponding disk drive) may be used as the storage device 1102. In one or more embodiments, a removable storage device (such as a flash drive, and its corresponding disk drive) may be used as the storage device 1102. Generally speaking, a computer-accessible medium may include non-transitory storage media or memory media, such as magnetic or optical media.

Like the storage device 1102, the system memory 1104 may be a read-and-write memory device. However, unlike the storage device 1102, the system memory 1104 may be a volatile read-and-write memory, such as random-access memory. The system memory 1104 may store any of the instructions and data that one or more processing unit 1116 may need at runtime to perform operations. Data may include one or more short-term data stores (e.g., caches and buffers). In one or more embodiments, the processes of the subject disclosure are stored in the system memory 1104 and/or the storage device 1102. From these various memory units, the one or more processing unit 1116 retrieves instructions to execute and data to process in order to execute the processes of one or more embodiments, discussed below.

Embodiments within the scope of the present disclosure may be partially or entirely realized using a tangible computer-readable storage medium (or multiple tangible computer-readable storage media of one or more types) encoding one or more instructions. The tangible computer-readable storage medium also may be non-transitory in nature.

The computer-readable storage medium may be any storage medium that may be read, written, or otherwise accessed by a general-purpose or special-purpose computing device, including any processing electronics and/or processing circuitry capable of executing instructions. For example, without limitation, the computer-readable medium may include any transitory semiconductor memory (e.g., the system memory 1104), such as RAM, DRAM, SRAM, T-RAM, Z-RAM, and TTRAM. The computer-readable medium also may include any non-transitory semiconductor memory (e.g., the storage device 1102), such as ROM, SSD, PROM, EPROM, EEPROM, NVRAM, flash, nvSRAM, FeRAM, FeTRAM, MRAM, PRAM, CBRAM, SONOS, RRAM, NRAM, racetrack memory, FJG, and Millipede memory.

Further, the computer-readable storage medium may include any non-semiconductor memory, such as optical disk storage, magnetic disk storage, magnetic tape, other magnetic storage devices, or any other medium capable of storing one or more instructions. In one or more embodiments, the tangible computer-readable storage medium may be directly coupled to a computing device, while in other embodiments, the tangible computer-readable storage medium may be indirectly coupled to a computing device, e.g., via one or more wired connections, one or more wireless connections, or any combination thereof.

Instructions may be directly executable or may be used to develop executable instructions. For example, instructions may be realized as executable or non-executable machine code or as instructions in a high-level language that may be compiled to produce executable or non-executable machine code. Further, instructions also may be realized as or may include data. Computer-executable instructions also may be organized in any format, including routines, subroutines, programs, data structures, objects, modules, applications, applets, functions, etc. As recognized by those of skill in the art, details including, but not limited to, the number, structure, sequence, and organization of instructions may vary significantly without varying the underlying logic, function, processing, and output.

While the above discussion primarily refers to microprocessors or multi-core processors that execute software, one or more embodiments are performed by one or more integrated circuits, such as ASICs or FPGAs. In one or more embodiments, such integrated circuits execute instructions that are stored on the circuit itself.

The bus 1110 also connects to the input device interface 1106 and output device interface 1108. The input device interface 1106 enables the system to receive inputs. For example, the input device interface 1106 allows a user to communicate information and select commands on the electronic system 1100. The input device interface 1106 may be used with input devices such as keyboards, mice, dials, switches, sliders, and other interfaces (physical or virtual) for a user to supply information to the electronic system 1100. The output device interface 1108 may be used with output devices such as displays, speakers, and other interfaces (physical or virtual) for the computing electronic system 1100 to provide information. One or more embodiments may include devices that function as both input and output devices, such as a touchscreen.

The bus 1110 also couples the electronic system 1100 to one or more networks and/or to one or more network nodes through the network interface 1114. The network interface 1114 may include one or more interfaces that allow the electronic system 1100 to be a part of a network of computers (e.g., a local area network (LAN), a wide area network (WAN), or a network of networks (the Internet)). For example, the network interface 1114 may include a network interface card (NIC).

A network set up by an entity, such as a company or a public sector organization, to provide one or more web services (such as various types of cloud-based computing or storage) accessible via the Internet and/or other networks to a distributed set of clients may be termed a provider network. Such a provider network may include numerous data centers hosting various resource pools, such as collections of physical and/or virtualized computer servers, storage devices, networking equipment and the like, needed to implement and distribute the infrastructure and web services offered by the provider network. The resources may in some embodiments be offered to clients in various units related to the web service, such as an amount of storage capacity for storage, processing capability for processing, as instances, as sets of related services and the like. A virtual computing instance may, for example, comprise one or more servers with a specified computational capacity (which may be specified by indicating the type and number of CPUs, the main memory size and so on) and a specified software stack (e.g., a particular version of an operating system, which may in turn run on top of a hypervisor).

A compute node, which may be referred to also as a computing node, may be implemented on a wide variety of computing environments, such as commodity-hardware computers, virtual machines, web services, computing clusters and computing appliances. Any of these computing devices or environments may, for convenience, be described as compute nodes.

A number of different types of computing devices may be used singly or in combination to implement the resources of the provider network in different embodiments, for example computer servers, storage devices, network devices and the like. In some embodiments a client or user may be provided direct access to a resource instance, e.g., by giving a user an administrator login and password. In other embodiments the provider network operator may allow clients to specify execution requirements for specified client applications and schedule execution of the applications on behalf of the client on execution platforms (such as application server instances, Java™ virtual machines (JVMs), general-purpose or special-purpose operating systems, platforms that support various interpreted or compiled programming languages such as Ruby, Perl, Python, C, C++ and the like or high-performance computing platforms) suitable for the applications, without, for example, requiring the client to access an instance or an execution platform directly. A given execution platform may utilize one or more resource instances in some embodiments; in other embodiments, multiple execution platforms may be mapped to a single resource instance.

In many environments, operators of provider networks that implement different types of virtualized computing, storage and/or other network-accessible functionality may allow customers to reserve or purchase access to resources in various resource acquisition modes. The computing resource provider may provide facilities for customers to select and launch the desired computing resources, deploy application components to the computing resources and maintain an application executing in the environment. In addition, the computing resource provider may provide further facilities for the customer to quickly and easily scale up or scale down the numbers and types of resources allocated to the application, either manually or through automatic scaling, as demand for or capacity requirements of the application change. The computing resources provided by the computing resource provider may be made available in discrete units, which may be referred to as instances. An instance may represent a physical server hardware platform, a virtual machine instance executing on a server or some combination of the two. Various types and configurations of instances may be made available, including different sizes of resources executing different operating systems (OS) and/or hypervisors, and with various installed software applications, runtimes, and the like. Instances may further be available in specific availability zones, representing a logical region, a fault tolerant region, a data center or other geographic location of the underlying computing hardware, for example. Instances may be copied within an availability zone or across availability zones to improve the redundancy of the instance, and instances may be migrated within a particular availability zone or across availability zones. As one example, the latency for client communications with a particular server in an availability zone may be less than the latency for client communications with a different server. As such, an instance may be migrated from the higher latency server to the lower latency server to improve the overall client experience.

In some embodiments the provider network may be organized into a plurality of geographical regions, and each region may include one or more availability zones. An availability zone (which may also be referred to as an availability container) in turn may comprise one or more distinct locations or data centers, configured in such a way that the resources in a given availability zone may be isolated or insulated from failures in other availability zones. That is, a failure in one availability zone may not be expected to result in a failure in any other availability zone. Thus, the availability container of a resource instance is intended to be independent of the availability container of a resource instance in a different availability zone. Clients may be able to protect their applications from failures at a single location by launching multiple application instances in respective availability zones. At the same time, in some embodiments inexpensive and low latency network connectivity may be provided between resource instances that reside within the same geographical region (and network transmissions between resources of the same availability zone may be even faster).

As set forth above, content may be provided by a content provider to one or more clients. The term content, as used herein, refers to any presentable information, and the term content item, as used herein, refers to any collection of any such presentable information. A content provider may, for example, provide one or more content providing services for providing content to clients. The content providing services may reside on one or more servers. The content providing services may be scalable to meet the demands of one or more customers and may increase or decrease in capability based on the number and type of incoming client requests. Portions of content providing services may also be migrated to be placed in positions of reduced latency with requesting clients. For example, the content provider may determine an “edge” of a system or network associated with content providing services that is physically and/or logically closest to a particular client. The content provider may then, for example, “spin-up,” migrate resources or otherwise employ components associated with the determined edge for interacting with the particular client. Such an edge determination process may, in some cases, provide an efficient technique for identifying and employing components that are well suited to interact with a particular client, and may, in some embodiments, reduce the latency for communications between a content provider and one or more clients.

As used in this specification and any claims of this application, the terms “base station,” “receiver,” “computer,” “server,” “processor,” and “memory” all refer to electronic or other technological devices. These terms exclude people or groups of people. For the purposes of the specification, the terms “display” or “displaying” means displaying on an electronic device.

The predicate words “configured to,” “operable to,” and “programmed to” do not imply any particular tangible or intangible modification of a subject but, rather, are intended to be used interchangeably. In one or more embodiments, a processor configured to monitor and control an operation or a component may also mean the processor being programmed to monitor and control the operation or the processor being operable to monitor and control the operation. Likewise, a processor configured to execute code may be construed as a processor programmed to execute code or operable to execute code.

Phrases such as an aspect, the aspect, another aspect, some aspects, one or more aspects, an implementation, the implementation, another implementation, some embodiments, one or more embodiments, an embodiment, the embodiment, another embodiment, some embodiments, one or more embodiments, a configuration, the configuration, another configuration, some configurations, one or more configurations, the subject technology, the disclosure, the present disclosure, other variations thereof and alike are for convenience and do not imply that a disclosure relating to such phrase(s) is essential to the subject technology or that such disclosure applies to all configurations of the subject technology. A disclosure relating to such phrase(s) may apply to all configurations or one or more configurations. A disclosure relating to such phrase(s) may provide one or more examples. A phrase such as an aspect or some aspects may refer to one or more aspects and vice versa, which applies similarly to other foregoing phrases.

The word “exemplary” is used herein to mean “serving as an example, instance, or illustration.” Any embodiment described herein as “exemplary” or as an “example” is not necessarily to be construed as preferred or advantageous over other embodiments. Furthermore, to the extent that the term “include,” “have,” or the like is used in the description or the claims, such term is intended to be inclusive in a manner similar to the phrase “comprise” as “comprise” is interpreted when employed as a transitional word in a claim.

All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public, regardless of whether such disclosure is explicitly recited in the claims.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein but are to be accorded the full scope consistent with the language claims, wherein reference to an element in the singular is not intended to mean “one and only one” unless specifically so stated, but rather “one or more.” Unless specifically stated otherwise, the term “some” refers to one or more. Headings and subheadings, if any, are used for convenience only and do not limit the subject disclosure.

What is claimed is:

1. A method, comprising:
applying, to each set of a plurality of sets of physical qubits of a quantum random access memory device, a first quantum state that is based on classical data bits that are stored in a classical memory device, wherein the applying of the first quantum state to each set of the plurality of sets of physical qubits, respectively produces an applied first quantum state;
encoding, into a plurality of groups of logical qubits, the applied first quantum states to respectively produce encoded first quantum states;
distilling the encoded first quantum states into a distilled quantum state;
performing a quantum teleportation of the distilled quantum state into a plurality of data qubits;
obtaining a classical measurement result of the quantum teleportation;
determining, via classical computing resources, correction information based on the classical measurement result of the quantum teleportation; and
obtaining a quantum superposition, based at least in part on a second quantum state determined using the correction information, of the classical data bits from the classical memory device.

2. The method of claim 1, wherein obtaining the quantum superposition of the classical data bits from the classical memory device comprises storing, as the obtained quantum superposition of the classical data bits from the classical memory device, a subsequent quantum teleportation of a subsequent distilled quantum state in the plurality of data qubits, wherein the subsequent quantum teleportation of the subsequent distilled quantum state comprises an error-free superposition of additional quantum states that are each based on one of the classical data bits from the classical memory device, and wherein the method further comprises:
performing, with a quantum processor separate from the quantum random access memory device, a quantum computation using the stored subsequent quantum teleportation of the subsequent distilled quantum state.

3. The method of claim 1, wherein each applied first quantum state includes a respective first error component.

4. The method of claim 3, wherein each encoded quantum state includes a respective second error component, wherein the distilling generates the distilled quantum state without the respective first error components or the respective second error components.

5. The method of claim 1, wherein obtaining the quantum superposition, based at least in part on the second quantum state determined using the correction information, the classical data bits from the classical memory device comprises:
applying, respectively to each set of the plurality of sets of physical qubits of the quantum random access memory device, a second quantum state, wherein the second quantum state is based on the correction information and the classical data bits that are stored in the classical memory device, and wherein the applying of the second quantum state to each set of the plurality of sets of physical qubits, respectively produces an applied second quantum state;
encoding, into the plurality of groups of logical qubits, the applied second quantum states to respectively produce encoded second quantum states;
distilling the encoded second quantum states into a second distilled quantum state;
performing a quantum teleportation of the second distilled quantum state into a plurality of data qubits;
obtaining a second classical measurement result of the quantum teleportation of the second distilled quantum state;
determining, via classical computing resources, second correction information based on the second classical measurement result of the quantum teleportation; and
obtaining, based at least in part on a third quantum state determined using the second correction information, the quantum superposition of the classical data bits from the classical memory device.

6. The method of claim 5, wherein obtaining, based at least in part on the third quantum state determined using the second correction information, the quantum superposition of the classical data bits from the classical memory device comprises:
repeating the applying, the encoding, the distilling, the quantum teleportation, and the determining until a classical measurement result of the quantum teleportation of a subsequent distilled quantum state indicates that the quantum teleportation of subsequent distilled quantum state is error free; and
storing the quantum teleportation of the subsequent distilled quantum state in the data qubits as the obtained quantum superposition of the classical data bits from the classical memory device.

7. The method of claim 1, wherein the data qubits are included in the quantum random access memory device.

8. The method of claim 1, wherein the data qubits are separate from the quantum random access memory device.

9. The method of claim 1, wherein each group of the plurality of groups of logical qubits utilizes a second respective set of the physical qubits of the quantum random access memory device.

10. The method of claim 1, wherein performing the quantum teleportation comprises applying, to each group of the plurality of groups of logical qubits, a respective group of quantum logical controlled-NOT (CNOT) gates, wherein each of the quantum logical CNOT gates target a corresponding one of the logical qubits that store the distilled quantum state and is controlled based on an additional quantum state initially stored by the data qubits.

11. The method of claim 10, wherein the classical measurement result comprises a group of measurements of a group of outputs of the group of quantum logical CNOT gates.

12. The method of claim 1, wherein determining the correction information based on the classical measurement result of the quantum teleportation comprises computing, using the classical computing resources:
a first bitwise sum of a plurality of address bits of the classical memory device and a plurality of corresponding values of the classical measurement result; and
a second bitwise sum of a plurality of the classical data bits at a plurality of first addresses corresponding to the plurality of address bits and a plurality of the classical data bits at a plurality of second addresses corresponding to the first bitwise sum.

13. The method of claim 1, wherein the distilling the encoded first quantum states comprises iteratively performing a series of swap test purification operations that receive the encoded first quantum states as inputs.

14. A quantum random access memory device, comprising:
physical qubits; and
control circuitry configured to:
apply, respectively to each set of a plurality of sets of the physical qubits, a first quantum state that is based on classical data bits that are stored in a classical memory device, wherein application of the first quantum state to each set of the plurality of sets of physical qubits, respectively produces an applied first quantum state;
encode, into a plurality of groups of logical qubits, the applied first quantum states to respectively produce encoded first quantum states;
distill the encoded first quantum states into a distilled quantum state;
perform a quantum teleportation of the distilled quantum state into a plurality of data qubits;
obtain a classical measurement result of the quantum teleportation; and
obtain a quantum superposition, based at least in part on a second quantum state determined using correction information determined using classical computing resources based on the classical measurement result of the quantum teleportation, of the classical data bits from the classical memory device.

15. The quantum random access memory device of claim 14, wherein quantum random access memory device is separate from and communicatively coupled to the classical memory device.

16. The quantum random access memory device of claim 14, wherein the control circuitry is configured to perform the quantum teleportation by applying, to each group of the plurality of groups of logical qubits, a respective group of quantum logical controlled-NOT (CNOT) gates, wherein each of the quantum logical CNOT gates target a corresponding one of the logical qubits that store the distilled quantum state and is controlled based on an additional quantum state initially stored by the data qubits.

17. The quantum random access memory device of claim 14, wherein:
the control circuitry is further configured to, after encoding the applied first quantum states and prior to distilling the encoded first quantum states, perform a partial Clifford twirling operation on the encoded first quantum states; and
the classical measurement result comprises a group of outputs of the group of quantum logical CNOT gates.

18. A quantum computer, comprising:
a quantum processor;
a classical memory device storing classical data bits;
a classical processor;
a quantum random access memory device comprising physical qubits; and
control circuitry configured to:
apply, to each set of a plurality of sets of the physical qubits, a first quantum state that is based on the classical data bits that are stored in the classical memory device, wherein application of the first quantum state to each set of the plurality of sets of physical qubits, respectively produces an applied first quantum state;
encode, into a plurality of groups of logical qubits, the applied first quantum states to respectively produce encoded first quantum states;
distill the encoded first quantum states into a distilled quantum state;
perform a quantum teleportation of the distilled quantum state into a distilled quantum state;
obtain a classical measurement result of the quantum teleportation;
determine, using the classical processor, correction information based on the classical measurement result of the quantum teleportation; and
obtain a quantum superposition, based at least in part on a second quantum state determined using the correction information, of the classical data bits from the classical memory device.

19. The quantum computer of claim 18, wherein the quantum processor is configured to perform a quantum computation using the quantum superposition of the classical data bits from the classical memory device.

20. The quantum computer of claim 18, wherein the control circuitry is configured to determine the correction information based on the classical measurement result of the quantum teleportation by computing, using the classical processor:
a first bitwise sum of a plurality of address bits of the classical memory device and a plurality of corresponding values of the classical measurement result; and
a second bitwise sum of a plurality of the classical data bits at a plurality of first addresses corresponding to the plurality of address bits and a plurality of the classical data bits at a plurality of second addresses corresponding to the first bitwise sum.
